(19) United States
(12) Patent Application Publication
(10) Pub. No.: US 2017/0009118 A1
(43) Pub. Date: Jan. 12, 2017

(54) METHOD AND APPARATUS FOR GENERATING LATENT HEAT AT LOW TEMPERATURES USING EXOTHERMIC SALT CRYSTALLIZATION

(71) Applicant: General Electric Company, Schenectady, NY (US)

(72) Inventors: Robert Edgar Colborn, Niskayuna, NY (US); William Dwight Gerstler, Niskayuna, NY (US); Carlos Enrique Diaz, Garching bei Munchen (DE); Maria Rocco LaTorre, Schenectady, NY (US)

(21) Appl. No.: 14/796,171

(22) Filed: Jul. 10, 2015

(51) Int. Cl. C09K 5/06; F02C 7/12

(52) U.S. Cl. CPC C09K 5/063; F02C 7/12

(57) ABSTRACT

A method and apparatus for generating latent heat at low temperatures using an exothermic salt crystallization reaction in a supersaturated solution. The method and apparatus includes a supersaturated solution including a salt-based solute in a solvent. In an embodiment, the supersaturated solution is comprised of a salt-based solute of at least 50 wt. % sodium acetate trihydrate in a solvent of 70 vol. % ethylene glycol and 30 vol. % water. The supersaturated solution remains stable at a temperature below a melting point of the salt-based solute and is triggered to crystallize in a controlled manner to generate latent heat. The method and apparatus further including an actuation component, in fluid communication with a lubricating fluid, to initiate an exothermic crystallization response in the supersaturated solution. The supersaturated solution is suitable for use in a heat exchanger apparatus of an engine. The crystallized salt will re-dissolve at elevated temperatures thus allowing for multiple use cycles.

### BACKGROUND

This disclosure relates generally to a means of generating heat at low temperatures, and more specifically to a method and apparatus for generating heat at low temperatures using exothermic salt crystallization.

Aviation engines use fluids, such as oil or fuel, to dissipate heat from engine components, such as engine bearings, electrical generators, and the like. Heat is typically rejected from the fluid by heat exchanger assemblies, systems of which include fuel-cooled oil coolers and air-cooled surface oil coolers, to maintain oil temperatures at a desired ˜100° F.<T<300° F. In many instances an environment in which the engine may be operated may be as low as −65° F. Fluids or other system components often work sub-optimally when at very low temperatures, for example below 32° F. Operation at these low temperatures often requires either: (i) sophisticated and expensive active heating controls that are often found unreliable; (ii) severe over-designing of the system, resulting in costlier, larger, and heavier parts; or (iii) compromising performance.

In a typical engine application, problems begin to occur when the engine is in an engine shut down occurrence in the low temperature condition. As used herein, the term “low temperature” is intended to encompass temperatures below 32° F. The oil within the heat exchanger apparatus begins to cool and may become very viscous. In many cases it will reach the ambient temperature, which may be as low as −65 F. As a result, due to the high viscosity of the oil, when the engine is restarted, the oil does not flow through the heat exchanger apparatus and requires a lengthy period of time to heat up the oil to a desired viscosity for flowing through the heat exchanger apparatus.

Known engines, and more particularly heat exchanger assemblies, have included oil ducts having increased diameter sizing in an attempt to allow for the continued flow of oil at start-up therethrough the assembly when operating during low temperature conditions. While these increased diameter ducts may provide for an increase or allowance in flow during low temperature conditions, the ducts are often oversized for normal operating conditions. In addition, these increased diameter ducts are cause of extra weight and bulk to the engine during all conditions of flight.

It would therefore be desirable to provide a passive, reliable, and inexpensive means to increase the temperature of a system component, such as oil or fuel, to a level where it is operable at a more desirable performance level. In particular, it would be desirable to provide a robust method and apparatus for providing sufficient heating to a lubricating or a heat transfer fluid, such as oil, passing through a system component during low temperature conditions that addresses the above issues.

### BRIEF SUMMARY

These and other shortcomings of the prior art are addressed by the present disclosure, which provides for the use of exothermic salt crystallization for latent heat at low temperatures.

In accordance with embodiment, provided is a supersaturated solution for use in a cooling system of an engine. The supersaturated solution includes a salt-based solute in a solvent and an actuation component. The supersaturated solution remaining stable at a temperature below a melting point of the salt-based solute and that may be triggered to crystallize in a controlled manner to generate latent heat. The actuation component is configured so as to initiate an exothermic crystallization reaction in the supersaturated solution.

In accordance with another embodiment, provided is a heat exchanger apparatus for use in an oil cooling system of an engine.

The heat exchanger apparatus including a supersaturated solution comprising a solute of at least 50 wt. % sodium acetate trihydrate in a solvent of ethylene glycol and water, one or more decongealing channels and an actuation component. The supersaturated solution is configured to remain stable at a temperature below a melting point of the sodium acetate trihydrate and that may be triggered to crystallize in a controlled manner to generate latent heat. Each of the one or more decongealing channels including a decongealing channel body enclosing therein the supersaturated solution. The actuation component is coupled to the decongealing channel body and in fluid communication with a lubricating fluid. The actuation component is responsive to at least one of an active trigger and a passive trigger to actuate an exothermic crystallization reaction in the supersaturated solution.

In accordance with yet another embodiment, provided is an engine. The engine including a fan assembly, a core engine downstream of the fan assembly, a fan casing substantially circumscribing the fan assembly, a booster casing substantially circumscribing the core engine such that a bypass duct is defined between the fan casing and the booster casing and a heat exchanger apparatus coupled to one of the fan casing or the booster casing. The heat exchanger apparatus including a supersaturated solution comprising a solute of at least 50 wt. % sodium acetate trihydrate in a solvent of ethylene glycol and water, one or more decongealing channels and an actuation component. The supersaturated solution is configured to remain stable at a temperature below a melting point of the sodium acetate trihydrate and that may be triggered to crystallize in a controlled manner to generate latent heat. Each of the one or more decongealing channels including a decongealing channel body enclosing therein the supersaturated solution. The actuation component is coupled to the decongealing channel body and in fluid communication with a lubricating fluid. The actuation component is responsive to at least one of an active trigger and a passive trigger to actuate an exothermic crystallization response in the supersaturated solution.

In accordance with yet another embodiment, provided is a method of decongealing a lubricating fluid in an engine component. The method including triggering an actuation component to initiate an exothermic crystallization reaction in a supersaturated solution in a controlled manner to generate latent heat, conducting the latent heat generated by the exothermic crystallization reaction to a congealed lubricating fluid and returning the supersaturated solution to a metastable state as the congealed lubricating fluid decongeals. The supersaturated solution includes a solute of at least 50 wt. % sodium acetate trihydrate in a solvent of 70 vol. % ethylene glycol and 30 vol. % water and configured to remain stable at a temperature below a melting point of the sodium acetate trihydrate, wherein the exothermic crystallization reaction is actuated by an actuation component.

Other objects and advantages of the present disclosure will become apparent upon reading the following detailed description and the appended claims with reference to the accompanying drawings.

### BRIEF DESCRIPTION OF THE FIGURES

These and other features, aspects, and advantages of the present disclosure will become better understood when the following detailed description is read with reference to the accompanying drawings in which like characters represent like parts throughout the drawings, wherein:

FIG. 1 is a schematic longitudinal cross-section of portion of an aircraft engine, in accordance with one or more embodiments shown or described herein;

FIG. 2 is a schematic longitudinal cross-section of portion of the aircraft engine of FIG. 1, including a heat exchanger apparatus, in accordance with one or more embodiments shown or described herein;

FIG. 3 is a boxplot of normalized energy released by various salt solutions in 70% ethylene glycol/30% water (by volume) solvent, in accordance with one or more embodiments shown or described herein; and

FIG. 4 illustrates steps in a method of generating latent heat at low temperatures using exothermic salt crystallization, in accordance with one or more embodiments shown or described herein.

Corresponding reference characters indicate corresponding parts throughout the several views of the drawings.

### DETAILED DESCRIPTION

The present disclosure will be described for the purposes of illustration only in connection with certain embodiments; however, it is to be understood that other objects and advantages of the present disclosure will be made apparent by the following description of the drawings according to the disclosure. While preferred embodiments are disclosed, they are not intended to be limiting. Rather, the general principles set forth herein are considered to be merely illustrative of the scope of the present disclosure and it is to be further understood that numerous changes may be made without straying from the scope of the present disclosure.

Preferred embodiments of the present disclosure are illustrated in the figures with like numerals being used to refer to like and corresponding parts of the various drawings. It is also understood that terms such as “top”, “bottom”, “outward”, “inward”, and the like are words of convenience and are not to be construed as limiting terms. It is to be noted that the terms “first,” “second,” and the like, as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity).

Embodiments disclosed herein relate to methods and apparatus for generating heat in an engine component through the use of exothermic salt crystallization in a solution. In an embodiment, a heat exchanger apparatus in an aircraft engine, such as an oil cooling or fuel cooling system, is disclosed in which the use of an exothermic salt crystallization reaction provides decongealing of a cooling fluid. In contrast to known means of heating fluids in components, the use of an exothermic salt crystallization reaction as disclosed herein provides for an inexpensive and reliable means for heating fluids in a cold operating condition without the need for an external source of energy. The use of latent heat generated by an exothermic salt crystallization reaction as disclosed herein provides for a system that is configured to weigh and cost less than known means that provide for the flow of congealed fluids, such as larger diameter pipes, or the like. In addition, the disclosed novel use of latent heat using an exothermic salt crystallization reaction minimizes the weight and cost of the overall apparatus. Accordingly, disclosed is the inclusion of a decongealing means that uses latent heat provided by an exothermic salt crystallization reaction for decongealing of a lubricating or heat transfer fluid in a component, such as an air or fuel cooled oil cooler, of an aviation engine.

As disclosed herein the use of an exothermic salt crystallization reaction to provide latent heat will be described in relation to an engine component, and in particular a heat exchanger apparatus. The heat exchanger apparatus including such use of latent heat, provided by the exothermic salt crystallization reaction, introduces a novel concept for passively providing for the decongealing of fluids, such as oil, during cold operating conditions in an engine, and more particularly in an aviation engine, such as an aircraft engine. The heat exchanger apparatus could also be used in a land based turbine engine, a diesel engine, internal combustion engine, or a chemical process apparatus, or any other application where heat needs to be generated when originally in a cold ambient condition state. The disclosed means for generating latent heat are additionally anticipated for use in any cooling system within aviation or land based engine (e.g. the cooling oil for the electrical generator of an aircraft engine or the lubrication oil of the aircraft engine). In an embodiment, the engine component is configured to include a closed volume of a supersaturated solution in the proximity of the congealed fluid flowing through the cooling system. The supersaturated solution, during normal operating conditions, is in a metastable state that will crystallize and generate heat in a controlled manner, in response to a trigger, such as, but not limited to, an active trigger or a passive trigger, such as a change in fluid pressure or the introduction of a nucleation site in the cooling system during operating or start up conditions. More specifically, in an embodiment a change in fluid pressure or the introduction of a nucleation site will drive an actuation means in the cooling system, and more particularly actuate the exothermic salt crystallization reaction, as required by the cooler operating concept, so as to provide for the generation of latent heat to decongeal the fluid, such as oil, passing therethrough. It is anticipated by this disclosure that the disclosed use of latent heat generated by the exothermic salt crystallization reaction is described in conjunction with an oil cooling system, but may also be applied to any other cooling fluid system (e.g. fuel cooled, hydraulic fluid or water systems) that undergo a similar triggering occurrence during operation in a cold condition so as to provide actuation of the heating process, and is not limited to the example oil cooled system described herein. Additional systems in which the disclosed use of latent heat generated by the exothermic salt crystallization reaction may be utilized include, but are not limited to, transportation control electronics (automobiles, trains, busses), batteries (automobile, trains, busses, building emergency power), mechanical and electrically actuated valves (component may benefit from heat to allow easier movement), or the like.

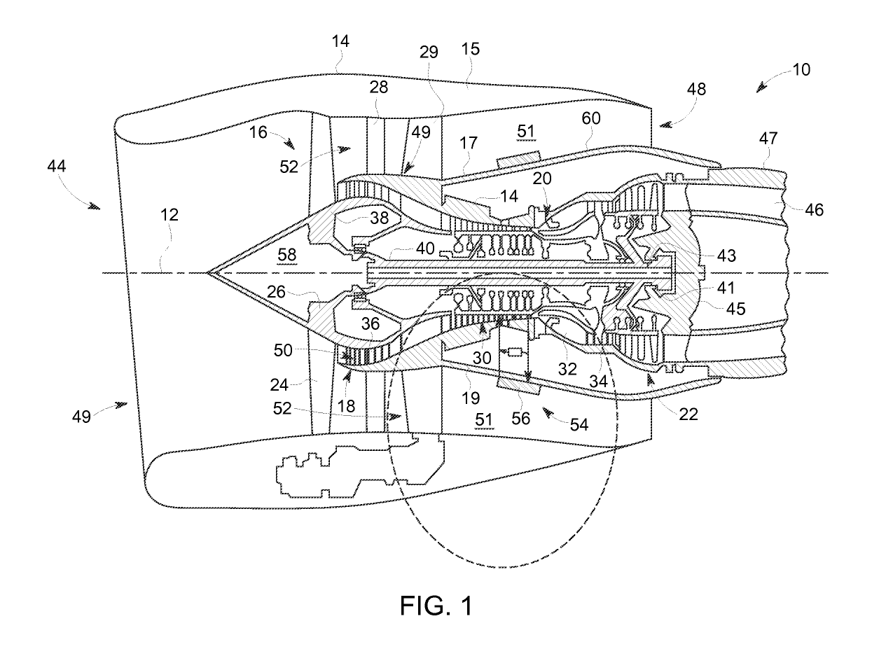

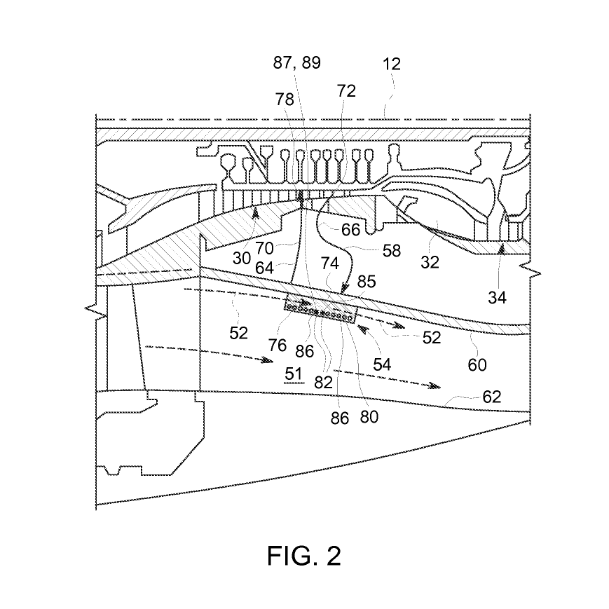

Referring to the drawings wherein identical reference numerals denote the same elements throughout the various views, FIGS. 1 and 2 depict a schematic illustration of an exemplary aircraft engine assembly 10, configured for use with the supersaturated solution for generating heat at low temperatures using exothermic salt crystallization as disclosed herein. It is noted that the portion of the engine assembly 10, illustrated in FIG. 2, is indicated by dotted line in FIG. 1. The engine assembly 10 has a longitudinal center line or axis 12 and an outer stationary annular fan casing 14 disposed concentrically about and coaxially along the axis 12. In the exemplary embodiment, the engine assembly 10 includes a fan assembly 16, a booster compressor 18, a core gas turbine engine 20, and a low-pressure turbine 22 that may be coupled to the fan assembly 16 and the booster compressor 18. The fan assembly 16 includes a plurality of rotor fan blades 24 that extend substantially radially outward from a fan rotor disk 26, as well as a plurality of structural strut members 28 and outlet guide vanes (“OGVs”) 29 that may be positioned downstream of the rotor fan blades 24. In this example, separate members are provided for the aerodynamic and structural functions. In other configurations, each of the OGVs 29 may be both an aerodynamic element and a structural support for an annular fan casing (described presently).

The core gas turbine engine 20 includes a high-pressure compressor 30, a combustor 32, and a high-pressure turbine 34. The booster compressor 18 includes a plurality of rotor blades 36 that extend substantially radially outward from a compressor rotor disk 38 coupled to a first drive shaft 40. The high-pressure compressor 30 and the high-pressure turbine 34 are coupled together by a second drive shaft 41. The first and second drive shafts 40 and 41 are rotatably mounted in bearings 43 which are themselves mounted in a fan frame 45 and a turbine rear frame 47. The engine assembly 10 also includes an intake side 44, defining a fan intake 49, a core engine exhaust side 46, and a fan exhaust side 48.

During operation, the fan assembly 16 compresses air entering the engine assembly 10 through the intake side 44. The airflow exiting the fan assembly 16 is split such that a portion 50 of the airflow is channeled into the booster compressor 18, as compressed airflow, and a remaining portion 52 of the airflow bypasses the booster compressor 18 and the core gas turbine engine 20 and exits the engine assembly 10 via a bypass duct 51, through the fan exhaust side 48 as bypass air. More specifically, the bypass duct 51 extends between an interior wall 15 of the fan casing 14 and an outer wall 17 of a booster casing 19. This portion 52 of the airflow, also referred to herein as bypass air flow 52, flows past and interacts with the structural strut members 28, the outlet guide vanes 29 and a heat exchanger apparatus (described presently). The plurality of rotor blades 24 compress and deliver the compressed airflow 50 towards the core gas turbine engine 20. Furthermore, the airflow 50 is further compressed by the high-pressure compressor 30 and is delivered to the combustor 32. Moreover, the compressed airflow 50 from the combustor 32 drives the rotating high-pressure turbine 34 and the low-pressure turbine 22 and exits the engine assembly 10 through the core engine exhaust side 46.

As previously noted, in certain presently available commercial engines heat exchanger apparatus are employed including a surface oil cooler or a generic air-cooled oil cooler. In accordance with exemplary aspects of the present technique, a supersaturated solution that provides latent heat in response to exothermic salt crystallization, within an engine component, such as a heat exchanger apparatus, is provided. The solution is suitable for use in a heat exchanger apparatus 54, as illustrated in FIGS. 1 and 2. The exemplary heat exchanger apparatus 54 may be configured to address the heat exchange requirements of a turbomachine such as an aircraft engine and provide for decongealing of a lubricating fluid, such as oil, in the apparatus 54 in extreme cold operating environments, for example. Hereinafter, the term “heat exchanger” may be used to refer to the apparatus 54 configured to facilitate cooling of the turbomachine. Furthermore, in an embodiment, the heat exchanger apparatus 54 may be configured as an air-cooled oil cooler (ACOC) a fuel-cooled oil cooler (FCOC), or any other heat exchanger using a heat transfer fluid or the like. The concept of using latent heat provided by exothermic salt crystallization disclosed herein is also applicable to any type of component found within an aircraft engine (e.g. piston, electric, etc.) including a heat exchange apparatus. Additional information regarding the use of such heat exchanger apparatus for decongealing a fluid is described in commonly assigned U.S. patent application bearing Ser. No. 14/502,750, C. Diaz, “Method and Apparatus for Decongealing a Lubricating Fluid in a Heat Exchanger Apparatus,” which is incorporated by reference herein in its entirety.

Referring more specifically to FIG. 2, illustrated is a schematic longitudinal cross-section of portion of the aircraft engine of FIG. 1, including the heat exchanger apparatus 54 including the supersaturated solution that provides latent heat in response to exothermic salt crystallization in greater detail. As illustrated, in the embodiment of FIGS. 1 and 2, the heat exchanger apparatus 54 is mounted to an interior surface 60, relative to axis 12, of the volume that defines the bypass duct 51 downstream of the strut members 28. In an alternate embodiment, the heat exchanger apparatus 54 may be mounted to the exterior surface 62, relative to the axis 12, of the volume that defines the bypass duct 51. In yet still another embodiment, the heat exchanger apparatus 54 may be disposed between the fan assembly 16 and upstream of the strut members 28 (FIG. 1).

During operation, portion 52 of the bypass airflow, flows past and interacts with the heat exchanger apparatus 54. As best illustrated in FIG. 2, during operation, hot lubricating fluid 58, and in this particular embodiment hot engine oil, is directed to the heat exchanger apparatus 54 via a first passage 66 and cooled lubricating fluid 64, and in this particular embodiment cooled engine oil, is directed back to the engine 10 via a second passage 70. In an embodiment, the first passage 66 may be connected on one side to a fluid outlet 72 of an engine block, or the like, and on the other side to a fluid inlet 74 of the heat exchanger 54. In addition, the second passage 70 is connected on one side to a fluid outlet 76 of the heat exchanger apparatus 54 and on the other side to a fluid inlet 78 of the engine block, or the like. In an alternate embodiment, the cooling system includes a lubricating fluid supply source (not shown) and one or more pumps which circulate the lubricating fluid to one or more bearings and to a gearbox and return the hot lubricating fluid to the lubricating fluid supply source via the heat exchanger apparatus 54 which cools it to a lower temperature.

As previously indicated in the illustrated embodiments, during normal operating conditions, heat is rejected from the hot lubricating fluid 58 to air (or alternatively another surrounding fluid) by the heat exchanger apparatus 54 to maintain fluid temperatures at a desired ˜100° F.<T<300° F. During engine start-up, while sitting in an extreme cold environment, such as, for example, in an environment approximately −65 F, the fluid that has been sitting in the heat exchanger apparatus 54 has excessively high viscosity, not allowing the lubricating fluid to pass therethrough. As a result, system pressure increases, forcing the oil to by-pass the heat exchanger until enough heat is conducted from the bypass valve area into the heat exchanger apparatus. Accordingly, the lubricating fluid must be heated to decongeal the lubricating fluid, lower the viscosity and decrease the pressure, and allow the lubricating fluid to start flowing through the heat exchanger apparatus 54.

In an exemplary embodiment, the heat exchanger apparatus 54 is a conformal air-cooled heat exchanger that is positioned within the bypass duct 51. Optionally, the heat exchanger apparatus 54 may be utilized in a wide variety of applications on or off the engine. More specifically, although in one embodiment the heat exchanger apparatus 54 may be described as configured to cool lubricating fluid for engine bearings, it may alternatively or simultaneously cool other fluids. For example, it may cool a fluid used to extract heat from generators or actuators used on the engine. It may also be used to cool fluids which extract heat from electronic apparatus such as engine controls. In addition to cooling a wide variety of fluids utilized by a gas turbine engine assembly, it should be realized that the heat exchanger apparatus 54, and the methods described herein illustrate that the heat exchanger apparatus 54 may also cool an apparatus that is mounted on the airframe, and not part of the engine. In other applications, the heat exchanger apparatus 54 may be mounted remotely from the gas turbine engine, for example on an external surface of the aircraft. Moreover, the heat exchanger apparatus 54 may be utilized in a wide variety of other applications to either cool or heat various fluids channeled therethrough.

In an embodiment, the heat exchanger apparatus 54 is selectively sized to receive the hot lubricating fluid 58 to be cooled therethrough. In an exemplary embodiment, the heat exchanger apparatus 54 encloses a plurality of parallel flow through channels 80 extending therethrough. In an embodiment, each of the parallel flow through channels 808 may all carry the same fluid, such as oil, or they may be segregated into multiple groups where each group carries a different cooling fluid used for different cooling purposes. For example, one group may carry lubrication fluid for the bearings, and another group might carry a separate cooling fluid for electronic apparatus on the engine.

In addition, the heat exchanger apparatus 54 also encloses at least one decongealing channel 82 extending therethrough that is selectively sized to contain therein a supersaturated solution 84 capable of decongealing the lubricating fluid 58 passing through the flow through channels 80, according to this disclosure. Optionally, the heat exchanger apparatus 54 may include a quantity greater than or less than the illustrated decongealing channels 82 based on the decongealing requirements. In the exemplary embodiment, each of the plurality of decongealing channels 82 has a substantially circular cross-sectional profile. Optionally, each of the plurality of decongealing channels 82 has a cross-sectional profile that is not circular such as for example, rectangular. Furthermore, the decongealing channels 82 are configured in parallel relationship, each defined by a decongealing channel body 85, extending circumferentially about the heat exchanger apparatus 54 that carry the same supersaturated solution 84.

As previously indicated, the at least one decongealing channel 82 is formed in the heat exchanger apparatus 54 and extending lengthwise therethrough to define a closed volume of the supersaturated solution 84 contained therein and capable of decongealing the lubricating fluid 58 passing through the at least one flow-through channel 80. In the exemplary embodiment, the heat exchanger apparatus 54 includes a plurality of parallel decongealing channels 82 extending circumferentially about the heat exchanger apparatus 54 that carry the supersaturated solution 84. Illustrated in FIG. 2, are two parallel decongealing channels 82 extending circumferentially about the heat exchanger apparatus 54. During operation, latent heat generated by the supersaturated solution 84 is conducted in an outward direction along a length of the decongealing channels 82, to provide heating of the lubricating fluid 58 flowing therethrough the flow through channels 80.

As previously stated, during startup or operation in extreme cold temperatures, the lubricating fluid 58 congeals. To provide decongealing of the lubricating fluid 58, the decongealing channels 82, having contained therein the supersaturated solution 84, are actuated to provide heat to the congealed lubricating fluid 58. As previously indicated, the one or more decongealing channels 82 define a closed volume, in which the supersaturated solution 84 is contained. In an embodiment, the supersaturated solution 84 comprises a salt-based solute 87 in a solvent 89. The supersaturated solution 84 remains stable at a temperature below a melting point of the solute 87 and may be triggered to crystallize in a controlled manner to generate latent heat. In an embodiment, the supersaturated solution 84 is comprised of a solute 87 of at least 50 wt. % sodium acetate trihydrate in a solvent 89 of ethylene glycol and water. In an embodiment, the supersaturated solution 84 is comprised of a solute 87 of at least 50-70 wt. % sodium acetate trihydrate in a solvent 89 of ethylene glycol and water. In an embodiment, the solvent 89 is 70 vol. % ethylene glycol and 30 vol. % water. In an embodiment, the supersaturated solution 84 is comprised of a solute 87 of 75 wt. % sodium acetate trihydrate in a solvent 89 of 70 vol. % ethylene glycol and 30 vol. % water.

As indicated, the supersaturated solution 84 is in a metastable state during a first operating condition, such as at engine shut down in temperature conditions typically between −65° F. and 136° F. During this first operating condition, the lubricating fluid 58 within the heat exchanger 54 is at a lower pressure than during engine operation. During a second operating condition, such as engine startup in temperature conditions typically between −65° F. and 136° F., the lubricating fluid 58 within the heat exchanger 54 may be exposed to an increase in pressure, thereby resulting in the supersaturated solution 84 to undergo an exothermic crystallization reaction. More specifically, during this second operating condition, actuation of the exothermic crystallization reaction is actuated by an actuation component 86. In an embodiment, pumping of the lubricating fluid 58 within the heat exchanger 54 increases the pressure of the lubricating fluid 58. This increase in pressure of the lubricating fluid causes actuation of the actuation component 86 that begins the crystallization process within the supersaturated solution 84 and creates nucleation sites that will initiate the exothermic crystallization reaction.

This exothermic crystallization reaction within the supersaturated solution 84 generates heat to provide decongealing of the lubricating fluid 58, and in a particular embodiment, oil, flowing through the flow through channels 80. During this second operating condition, heat generated by the supersaturated solution 84 is conducted in an outward direction to the adjacent flow through channels 80, to provide heating of the congealed lubricating fluid 54 flowing therethrough the flow through channels 80.

In an embodiment, and as best illustrated in FIG. 2, each of the one or more decongealing channels 82 includes one or more actuation components 86 to actuate the crystallization heating process upon a rise in pressure of the lubricating fluid 58 flowing through the one or more flow through channels 80. To provide decongealing of the lubricating fluid 58, heat is generated in the one or more decongealing channels 82 and conducted through the channel sidewalls and toward the congealed lubricating fluid 58 flowing through the flow through channels 80. As previously indicated, each of the one or more decongealing channels 82 defines a closed volume having the supersaturated solution 84 contained therein. Such actuation component 86 may include at least one of a seed crystal, a metal disk, or actuation by one or more bubbles providing a surface for crystallization, present in the supersaturated solution. Other actuating mechanisms known in the art, such as, but not limited to the use of dual metal disc, or the like, can be used as an actuation component for actuating the exothermic crystallization reaction in the supersaturated solution 84. The actuation component 86 is capable of generating one or more nucleation sites within the supersaturated solution 84.

Subsequent to actuation of the exothermic crystallization reaction in the supersaturated solution 86, the heat from the crystallization process is conducted through the sidewalls of the decongealing channels 82 and through the flow through channels 80 and transferred to the congealed lubricating fluid 58 in the plurality of flow through channels 80. This transfer of heat provides a decrease in the viscosity of the lubricating fluid 58 within the one or more flow through channels 80 causing it to flow freely therethrough. It is anticipated that the time for the lubricating fluid 58 in the one or more flow through channels 80 to decongeal and begin flowing within the heat exchanger apparatus 54 may be reduced using the disclosed method and apparatus for generating latent heat at low temperatures using exothermic salt crystallization in a supersaturated solution.

When the surrounding environment is of a predetermined warmer temperature, the supersaturated solution 84 will return to its metastable state. Once back in the metastable state, the supersaturated solution 84 can remain in the metastable state (even when in a non-operating cold environment) as long as it is not triggered. More specifically, during continued operation, such as during warm engine operation on ground or in flight conditions, and continued dissipation of the heat generated by the warm/hot engine assembly 10 and transported by the oil to the adjacent walls where the solute 87 of the supersaturated solution 84 has precipitated, the supersaturated solution 84 will return to its metastable state in a reversible process when the temperature exceeds 136° F. In such a warm environment, the supersaturated solution 84 returns to a state where the solute 87 is completely dissolved in the solvent 89 as the solubility increases with the temperature. In that the process is reversible, in an aerospace application, the process can be initiated at the beginning of each flight in a complete autonomous and passive way. It is anticipated that the described method of generating latent heat using exothermic salt crystallization in a heat exchanger apparatus 54 could be used for any engine operating at very low temperature/arctic conditions (automotive, military, oil and gas, spacecraft).

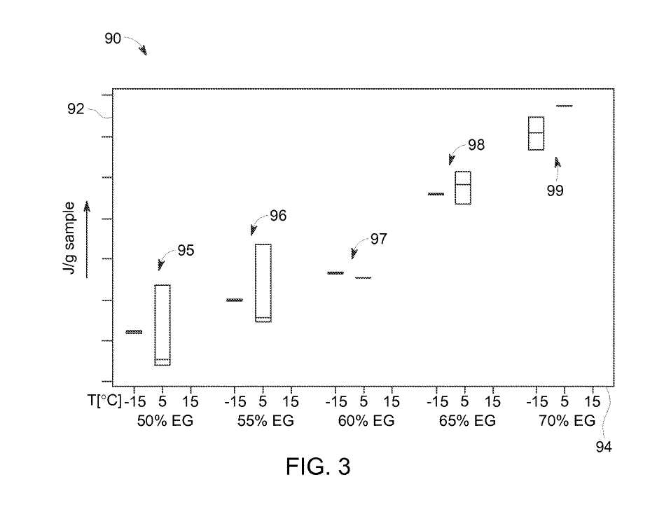

Referring now to FIG. 3, provided is a boxplot 90 in which numerical data is plotted in graphically depicted groups through their quartiles. More particularly, boxplot 90 illustrates normalized energy released, as plotted on axis 92, by various salt solutions in a 70% ethylene glycol/30% water (by volume) solvent, as plotted on axis 94, and that may comprise the supersaturated solution 84 described herein. In the illustrated plot 90, percent EG indicates percentage of salt by mass dissolved in the ethylene glycol-water mixture.

Aqueous salt solutions are known to have meta-stable super saturated states where the solution remains liquid at temperatures below the normal crystallization temperature (and remains so until triggered). These type of solutions are known to convert to a solid state with no trigger mechanism when the temperature approaches the pure solvents (e.g., water) nominal freeze/melt temperature. It is also known that various substances and mixtures have freeze/melt temperatures below that of water. It has not been found that any of these low freeze/melt point substances are capable of working with salt as a triggerable heat generating solution at low temperature. One reason being the solubility of the salt in the mixture and whether it is sufficient to generate practical amounts of heat (Soleymani J, Zamani-Kalajahi M, Ghasemi B, Kenndler E, Jouyban A. Solubility of Sodium Acetate in Binary Mixtures of Methanol, 1-Propanol, Acetonitrile, and Water at 298.2 K. J Chem Eng Data. 2013; 58(12):3399-404). Accordingly, experimentation was conducted to determine if a supersaturated solution that is meta-stable provides for the solution to remain liquid below the nominal solution crystallization temperature until triggered. In addition, experimentation was conducted to determine when a meta-stable supersaturated state does exist, whether it remains stable at temperatures low enough to be of interest.

Referring more specifically to FIG. 3, illustrated is exemplary data for various salt concentrations in a particular mixture of water and ethylene glycol, such that may comprise the supersaturated solution 84 described herein. As previously indicated, the % EG number as shown, refers to the percentage of salt by weight dissolved into a mixture of ethylene glycol and water. In FIG. 3, experimentation was conducted using an ethylene glycol/water mixture, and more specifically a 70% ethylene glycol/30% water, by volume. Data is shown illustrating the range of measured energy released at temperatures of −15° and 5° C., normalized to the mass of the sample (sum of the salt, glycol, and water). More particularly, data 95 is shown for a supersaturated solution comprising 50% salt by weight dissolved into a mixture of 70% ethylene glycol/30% water, by volume. Data 96 is shown for a supersaturated solution comprising 55% salt by weight dissolved into a mixture of 70% ethylene glycol/30% water, by volume. Data 97 is shown for a supersaturated solution comprising 60% salt by weight dissolved into a mixture of 70% ethylene glycol/30% water, by volume. Data 98 is shown for a supersaturated solution comprising 65% salt by weight dissolved into a mixture of 70% ethylene glycol/30% water, by volume. Data 99 is shown for a supersaturated solution comprising 70% salt by weight dissolved into a mixture of 70% ethylene glycol/30% water, by volume. As illustrated, data 95, 96, 97, 98 and 99 shows that the higher the percentage of dissolved salt, results in more energy released per mass of the solution. Data 95, 96, 97, 98 and 99 additionally illustrates the amount of energy released is not adversely affected by the temperature. While FIG. 3 illustrates a limited amount of data for a limited range of temperatures, the concept has been demonstrated with solutions that remain stable and are triggerable down to below −55° C.

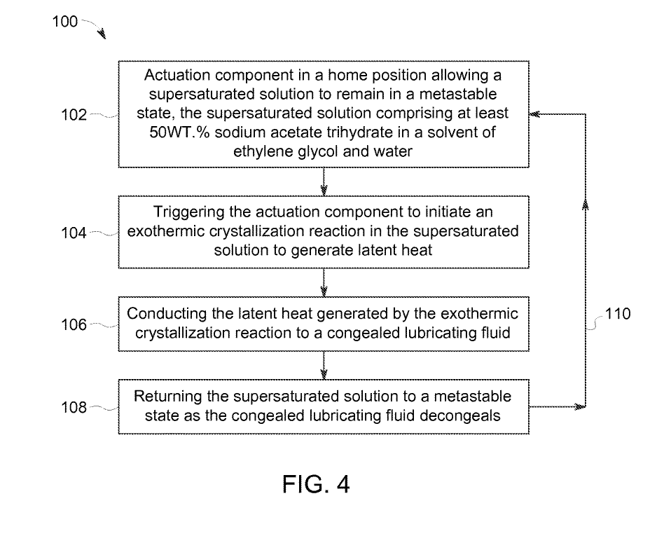

FIG. 4 illustrates steps in a method 100 of generating heat through the use of exothermic salt crystallization. The method is applicable to a heat exchanger apparatus including one or more decongealing channels, such as the heat exchanger apparatus 54 and decongealing channels 82 of FIGS. 1 and 2. As previously described, a change in temperature in which the heat exchanger 54 is operated, will effect a change in viscosity and therefore the pressure of the flow of the lubricating fluid 58 therethrough and thus the properties of the included actuation component 86. Initially, at a step 102, the actuation component 86 is in a home position allowing the supersaturated solution 84 to remain in a metastable state. As disclosed, the supersaturated solution 84 comprises a solute 87 of at least 50 wt. % sodium acetate trihydrate in a solvent 89 of ethylene glycol and water. In an embodiment, the supersaturated solution 84 is comprised of a solute 87 of 50-70 wt. % sodium acetate trihydrate in a solvent 89 of ethylene glycol and water. In an embodiment, the solvent 89 is 70 vol. % ethylene glycol and 30 vol. % water. In an embodiment, the supersaturated solution 84 is comprised a solute 87 of 75 wt. % sodium acetate trihydrate in a solvent 89 of 70 vol. % ethylene glycol and 30 vol. % water.

Next, at a step 104, upon startup of the engine in an operating condition sufficiently cool to require decongealing of the lubricating fluid 58, triggering of the actuation component 86 takes place to initiate the exothermic crystallization process in the supersaturated solution 84. More particularly, the exothermic crystallization process is initiated in response to at least one of an active trigger or a passive trigger. By way of example, in an embodiment, a crew would actively trigger, or engage, the actuation component 86 to initiate the exothermic crystallization process in the supersaturated solution 84, the generation and conduction of heat through the channel walls, and decongealing of the flow of lubricating fluid 58 within the heat exchanger apparatus 54. Accordingly, in this particular embodiment in step 104, the actuation component 86, in response to an active trigger, initiates the exothermic crystallization reaction in the supersaturated solution 84 to generate latent heat.

In an alternate embodiment, the exothermic crystallization process is initiated in response to a passive trigger. More particularly, a component, such as a mechanical mechanism is configured to activate the actuation component 86 in response to a rise in pressure (passive trigger) to initiate the exothermic crystallization process in the supersaturated solution 84. By way of example, upon startup of a cold engine, the oil in the ACOC is too viscous to flow. An oil bypass valve allows the oil to bypass the ACOC. A mechanical mechanism, disposed in the by-pass valve area, is configured to operate via the STATIC pressure in the by-pass valve (not via the flow). When the static pressure reaches a predetermined level (passive trigger), the mechanical mechanism activates the actuation component 86. In an embodiment, the mechanical mechanism is a mechanical linkage, a material that grows thermally and is mechanically connected to a motion multiplier, a shape memory alloy material, or the like. Accordingly, in this particular embodiment in a step 104, the actuation component 86, in response to a passive trigger, initiates the exothermic crystallization reaction in the supersaturated solution 84 to generate latent heat.

Upon actuation of the actuation component 86, and more particularly the exothermic crystallization process in the supersaturated solution 84, generated heat is conducted through the channel walls of the one or more decongealing channels 82 and ultimately through the flow through channels 80, to the congealed lubricating fluid 58 for decongealing purposes, at a step 106.

Finally, in a step 108, as the lubricating fluid 58 decongeals and each of the actuation components 86 return to the home position as heat dissipates from the supersaturated solution 84. As the engine assembly 10 produces heat during operation, the supersaturated solution 84 changes to a state where the solute crystals are completely dissolved in the solvent 89 within the one or more decongealing channels 82. The process can then be repeated, at step 110, as required.

Accordingly disclosed is a novel method and apparatus for generating latent heat at low temperatures using exothermic salt crystallization in a supersaturated solution. In an embodiment, the solution is comprised of a solute of 75 wt. % sodium acetate trihydrate in a solvent of 70 vol. % ethylene glycol and 30 vol. % water. The supersaturated solution is suitable for use in a heat exchanger apparatus of an engine, including one or more decongealing channels. This disclosed novel solution has several advantages. Among them, it is inexpensive to manufacture, reliable and does not require an external source of energy to generate heat. A heat exchanger apparatus, including the novel solution, weighs less than prior art by-heat exchangers including a means for providing flow of congealed fluid or assemblies including other types of lubricating fluid warmers.

The foregoing has described a novel method and apparatus for generating latent heat at low temperatures using exothermic salt crystallization in a supersaturated solution. While the present disclosure has been described with respect to a limited number of embodiments, those skilled in the art, having benefit of this disclosure, will appreciate that other embodiments may be devised which do not depart from the scope of the disclosure as described herein. While the present disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the present disclosure without departing from the essential scope thereof For example, the novel method and apparatus for generating latent heat at low temperatures using exothermic salt crystallization may be configured for use in many different types of engines, such as aircraft engine architectures, in addition to the example engine described herein, such as, but not limited to a multi-spool design (additional compressor and turbine section), a geared turbo fan type architecture, engines including un-ducted fans, single shaft engine designs (single compressor and turbine sections), or the like. In addition, the novel method and apparatus for generating latent heat at low temperatures using exothermic salt crystallization disclosed herein will work equally well with other types of fluid cooled heat exchanger apparatus, and as such is not intended to be limited to surface coolers, and may be configured for use in other types of surface coolers, such as plate and fin, channel-fin type, or the like would benefit as well. Therefore, it is intended that the present disclosure not be limited to the particular embodiment disclosed as the best mode contemplated for carrying out the disclosure. It is, therefore, to be understood that the appended claims are intended to cover all such modifications and changes as fall within the true spirit of the disclosure.

What is claimed is:

1. A supersaturated solution for use in a cooling system of an engine comprising:
a salt-based solute in a solvent, the supersaturated solution remaining stable at a temperature below a melting point of the salt-based solute, the supersaturated solution producing an exothermic crystallization reaction in response to a trigger by an actuation component, the supersaturated solution crystallizing in a controlled manner to generate latent heat.

2. The supersaturated solution as claimed in claim 1, wherein the salt-based solute is sodium acetate trihydrate.

3. The supersaturated solution as claimed in claim 2, wherein the salt-based solute is 50 wt. % or greater.

4. The supersaturated solution as claimed in claim 3, wherein the salt-based solute is 50-70 wt. %.

5. The supersaturated solution as claimed in claim 3, wherein the salt-based solute is 75 wt. %.

6. The supersaturated solution as claimed in claim 1, wherein the solvent is ethylene glycol and water.

7. The supersaturated solution as claimed in claim 6, wherein the solvent is 70 vol. % ethylene glycol and 30 vol. % water.

8. The supersaturated solution as claimed in claim 7, wherein the salt-based solute is 50-70% salt by weight dissolved into the solvent of 70 vol. % ethylene glycol and 30 vol. % water.

9. The supersaturated solution as claimed in claim 1, wherein the actuation component is at least one of a seed crystal, a metal disk, and at least one bubble, the actuation component capable of generating one or more nucleation sites in the supersaturated solution.

10. The supersaturated solution as claimed in claim 1, wherein the supersaturated solution is configured for use in an aerospace application.

11. The supersaturated solution as claimed in claim 1, wherein the supersaturated solution is configured for use in a decongealing channel of an oil cooling system of an aircraft engine.

12. A heat exchanger apparatus for use in an oil cooling system of an engine comprising:
a supersaturated solution comprising a solute of at least 50 wt. % sodium acetate trihydrate in a solvent of ethylene glycol and water, the supersaturated solution configured to remain stable at a temperature below a melting point of the sodium acetate trihydrate and that may be triggered to crystallize in a controlled manner to generate latent heat;
one or more decongealing channels, each of the one or more decongealing channels comprising a decongealing channel body enclosing therein the supersaturated solution; and
an actuation component coupled to the decongealing channel body and in fluid communication with a lubricating fluid, the actuation component responsive to at least one of an active trigger and a passive trigger to actuate an exothermic crystallization reaction in the supersaturated solution.

13. The heat exchanger apparatus as claimed in claim 12, wherein the solute is 50-70 wt. % sodium acetate trihydrate.

14. The heat exchanger apparatus as claimed in claim 12, wherein the solvent is 70 vol. % ethylene glycol and 30 vol. % water.

15. The heat exchanger apparatus as claimed in claim 14, wherein the solute is 50-70 wt. % sodium acetate trihydrate dissolved into the solvent of 70 vol. % ethylene glycol and 30 vol. % water.

16. The heat exchanger apparatus as claimed in claim 12, wherein the actuation component is at least one of a seed crystal, a metal disk and at least one bubble, the actuation component capable of generating one or more nucleation sites in the supersaturated solution.

17. The heat exchanger apparatus as claimed in claim 12, wherein the supersaturated solution is configured for use in an aerospace application to provide latent heat in temperatures less than 32° F.

18. An engine comprising:
a fan assembly;
a core engine downstream of the fan assembly;
a fan casing substantially circumscribing the fan assembly;
a booster casing substantially circumscribing the core engine such that a bypass duct is defined between the fan casing and the booster casing; and
a heat exchanger apparatus coupled to one of the fan casing or the booster casing, the heat exchanger apparatus comprising:
a supersaturated solution comprising a solute of at least 50 wt. % sodium acetate trihydrate in a solvent of ethylene glycol and water, the supersaturated solution configured to remain stable at a temperature below a melting point of the sodium acetate trihydrate and that may be triggered to crystallize in a controlled manner to generate latent heat;
one or more decongealing channels, each of the one or more decongealing channels comprising a decongealing channel body enclosing therein the supersaturated solution; and
an actuation component coupled to the decongealing channel body and in fluid communication with a lubricating fluid, the actuation component responsive to at least one of an active trigger and a passive trigger to actuate an exothermic crystallization response in the supersaturated solution.

19. The engine of claim 18, wherein the solvent is 70 vol. % ethylene glycol and 30 vol. % water.

20. A method of decongealing a lubricating fluid in an engine component, the method comprising:
triggering an actuation component to initiate an exothermic crystallization reaction in a supersaturated solution in a controlled manner to generate latent heat, the supersaturated solution comprising a solute of at least 50 wt. % sodium acetate trihydrate in a solvent of 70 vol. % ethylene glycol and 30 vol. % water and configured to remain stable at a temperature below a melting point of the sodium acetate trihydrate;
conducting the latent heat generated by the exothermic crystallization reaction to a congealed lubricating fluid; and
returning the supersaturated solution to a metastable state as the congealed lubricating fluid decongeals.
